(19) United States
(12) Patent Application Publication
(10) Pub. No.: US 2010/0303683 A1
(43) Pub. Date: Dec. 2, 2010

(54) COOLING MODULE AND REACTOR COMPRISING THE SAME

(76) Inventors: Kelvin John Hendrie, Amsterdam (NL); Wouter Van Maaren, Amsterdam (NL); Remco Schilthuizen, Amsterdam (NL); Barend Roeland Vermeer, Amsterdam (NL); Ronald Vladimir Wisman, Amsterdam (NL)

Correspondence Address: SHELL OIL COMPANY, P O BOX 2463, HOUSTON, TX, 772522463, US

(21) Appl. No.: 12/770,511

(22) Filed: Apr. 29, 2010

(30) Foreign Application Priority Data
May 4, 2009 (EP) 09159295.6

(51) Int. Cl. B01J 19/00

(52) U.S. Cl. 422/198

(57) ABSTRACT

The invention comprises a cooling module for use in a reactor for carrying out an exothermic process, such as a Fischer-Tropsch process, comprising a coolant inlet, a coolant distribution chamber, a plurality of cooling tubes, a coolant collection chamber, and a coolant discharge. A plurality of tubes extend through the distribution chamber to enable fluid communication between the space on one side of the distribution chamber and the space between the cooling tubes, and wherein at least 80% of the cooling tubes are arranged separately with a distance to the nearest cooling tube of at least 1 cm.

This application claims the benefit of European Application No. 09159295.6 filed May 4, 2009, which is incorporated herein by reference.

### BACKGROUND OF THE INVENTION

The present invention relates to a cooling module for use in a reactor for carrying out an exothermic process, such as a Fischer-Tropsch process, comprising a coolant inlet, a coolant distribution chamber, a plurality of cooling tubes, a coolant collection chamber, and a coolant discharge. The invention further relates to a reactor for carrying out an exothermic process comprising a plurality of such cooling modules. The invention further relates to the use of such a reactor for carrying out an exothermic process.

As is explained in WO 2005/075065, Fischer-Tropsch processes are often used for the conversion of gaseous hydrocarbon feedstocks into liquid and/or solid hydrocarbons. The feedstock, e.g. natural gas, associated gas, coal-bed methane, residual (crude) oil fractions, coal and/or biomass is converted in a first step to a mixture of hydrogen and carbon monoxide, also known as synthesis gas or syngas. The synthesis gas is then converted in a second step over a suitable catalyst at elevated temperature and pressure into paraffinic compounds ranging from methane to high molecular weight molecules comprising up to 200 carbon atoms, or, under particular circumstances, more.

Numerous types of reactor systems have been developed for carrying out the Fischer-Tropsch reaction. Fischer-Tropsch reactor systems include fixed bed reactors, in particular multi-tubular fixed bed reactors, fluidized bed reactors, such as entrained fluidized bed reactors and fixed fluidized bed reactors, and slurry bed reactors, such as three-phase slurry bubble columns and ebullated bed reactors.

The Fischer-Tropsch reaction is highly exothermic and temperature sensitive and thus requires careful temperature control to maintain optimum operating conditions and hydrocarbon product selectivity.

Commercial fixed-bed and three-phase slurry reactors typically utilize boiling water to remove reaction heat. In fixed-bed reactors, individual reactor tubes are located within a shell containing water/steam typically fed to the reactor via flanges in the shell wall. The reaction heat raises the temperature of the catalyst bed within each tube. This thermal energy is transferred to the tube wall forcing the surrounding water to boil. In the slurry design, cooling tubes are placed within the slurry volume and heat is transferred from the liquid continuous matrix to the tube walls. The production of steam within the tubes provides cooling.

It would be an advancement in the art to provide a cooling module which allows relatively simple yet robust construction and operation.

### SUMMARY OF THE INVENTION

The cooling module according to the present invention is characterized in that one or more passages extend through the distribution chamber to enable fluid communication between the space on one side of the distribution chamber, typically underneath the distribution chamber, and the space between the cooling tubes.

### BRIEF DESCRIPTION OF THE DRAWINGS

FIG. 1 is a vertical cross-section of a reactor according to the present invention.

FIGS. 2 and 3 are lateral cross-sections, at II and at III respectively, of the reactor shown in FIG. 1. FIG. 2 shows a gas distribution system. FIG. 3 shows coolant inlet piping.

FIGS. 4A and 4B are perspective views of a cooling module used in the reactor shown in FIG. 1.

FIGS. 5A and 5B are perspective views of the distribution chamber used in the cooling module used in the reactor shown in FIGS. 4A and 4B.

FIG. 6 is a top view of the distribution chamber shown in FIGS. 5A and 5B.

FIG. 7 is a top view of a perforated baffle.

FIGS. 8 and 9 show two different embodiments of a gas trap and gas supply for the cooling modules.

### DETAILED DESCRIPTION OF THE INVENTION

The cooling module is suitable for use in a reactor for carrying out an exothermic process, such as a Fischer-Tropsch process. The cooling module comprises a coolant inlet, a coolant distribution chamber, a plurality of cooling tubes, a coolant collection chamber, and a coolant discharge.

The cooling tubes are arranged as separate cooling tubes. When the cooling module is in use, coolant may pass from the coolant distribution chamber through the cooling tubes to the coolant collection chamber. Preferably at least 80%, more preferably at least 90%, of the cooling tubes are arranged separately with a distance to the nearest cooling tube of at least 1 cm, preferably at least 2 cm. Preferably at least 80%, more preferably at least 90%, of the cooling tubes have a distance of at least 1 cm, preferably at least 2 cm, to its nearest cooling tube along the length of the cooling tubes. The distance between two adjacent cooling tubes in the cooling module of the present invention preferably is less than 50 cm, more preferably less than 20 cm, along the length of the cooling tubes.

A cooling module according to the present invention is especially suitable for use in a slurry reactor. In that case the cooling tubes of the cooling module are placed within the volume in which the reaction takes place and heat is transferred from the liquid continuous matrix to the tube walls. The catalyst in the reaction volume may be a particulate catalyst. Additionally or alternatively, the catalyst in the reaction volume may be a structured catalyst, for example a shaped porous structure. A structured catalyst may form an ebullated bed. A structured catalyst may be fixed in the reaction volume. A slurry reactor in which the catalyst is fixed is sometimes referred to as “immobilized slurry reactor”.

The passages, preferably a plurality of tubes, extending through the distribution chamber on the one hand provide an effective (upward) passage for the (gaseous) reactants and, in some embodiments, passage of the (liquid) product and on the other hand enable a relatively straightforward construction of the bottom header and, if desired, the top header of the cooling module.

Further, if the passages are evenly distributed, e.g. in rows or in a pattern having a square, rectangular or triangular pitch, over the cross-section of the distribution chamber, the bottom header contributes to an even distribution of gaseous reactants entering the module.

In another aspect, at least one of the distribution chamber and the collection chamber comprises two at least substantially parallel plates interconnected by means of the passage tubes. As a result of this structural connection, the passage tubes add to the mechanical strength of the header and bear part of the internal and external pressure load, exerted by the (evaporating) cooling medium and reactants and product respectively, as well as the structural load exerted on the bottom header by the mass of the module itself.

In another aspect, a structured catalyst is placed between the cooling tubes, such as shaped porous structures e.g. woven or non-woven and optionally compressed metal fabrics, e.g. in the form of sheets or contained in a cage. This configuration combines the advantage of a fixed bed reactor in that substantially no filtering of catalyst particles is required and the advantage of a slurry reactor, i.e. relatively high transfer of heat from the product to the coolant.

In another aspect, the cooling tubes are enveloped by one or more walls to contain reactants and product within the module, thus compartmentalizing the reactor in the radial direction and preferably at least up to the level of the structured catalyst (catalyst bed) in the reactor. Compartmentalizing the reactor facilitates scaling up in that a larger reactor can be obtained by using more of the same compartments (multiplication) having predictable hydrodynamic behavior. Thus, large scale hydrodynamics can be avoided and the risks of scaling up are reduced.

In one aspect, the reactor comprises several cooling modules, at least one cooling module being enveloped by one or more walls. Two walls may be connected to each other. Alternatively, there may be a space between two adjacent walls along the side of the walls which is substantially parallel to the length of the cooling tubes. The length of the walls may, for example, extend along the cooling tubes from the distribution chamber up to the collection chamber of the cooling module. Alternatively, the walls may, for example, extend along the cooling tubes from the top of the distribution chamber up to about 50 to 70% of the length of the cooling tubes. The distance between two opposite substantially parallel walls preferably is in the range of from 0.5 m to 10 m, more preferably in the range of from 0.5 m to 6 m, even more preferably in the range of from 0.5 m to 3 m. A wall preferably has a thickness in the range of from 0.5 mm to 12 mm, more preferably in the range of from 2 to 10 mm. The width of a wall preferably is in the range of from 5 cm to 15 m, more preferably in the range of from 1 m to 9 m.

In yet another aspect, the reactor comprises one or more perforated baffles, preferably at regular intervals along the length of the cooling tubes. The flow of gas and liquid can be influenced by selecting a suitable pattern for and dimensions of the perforations. I.e., the baffles can used as redistributors for the gas and liquid inside the modules. Further, the baffles can provide support for any catalyst system that might be installed between cooling tubes and add mechanical strength to the module, e.g. by preventing tube buckling and module twisting. Baffles are preferably placed substantially horizontal.

The shape, size and configuration of the cooling modules and their arrangement within a reactor are governed primarily by factors such as the capacity, operating conditions and cooling requirements of the reactor. The cooling modules may have any cross-section which provides for efficient packing of cooling modules within a reactor, for example, the cooling module may be of square, triangular, rectangular, trapezoidal (especially covering three equilateral triangles) or hexagonal cross-section. A cooling module having a square cross-section is advantageous in terms of lateral movement of the modules within the reactor during installation and removal and in providing uniform cooling throughout the reactor volume.

The cross-sectional area of the cooling modules may typically be about 0.1 to 5.00 m², preferably about 0.16 to 2.00 m², depending on the number and configuration of cooling tubes employed and the cooling capacity required.

The cooling tubes preferably have a length of about 4 to about 40 metres, more preferably a length of about 10 to about 25 metres. A cooling tube may have any cross section, for example, square or circular, preferably circular. Further, the outer diameter of each of the cooling tubes is preferably in a range from about 1 to about 10 cm, more preferably in a range from about 2 to about 5 cm.

The invention further relates to a reactor for carrying out an exothermic process comprising a reactor shell, inlets for introducing reactants and coolant into the reactor shell, outlets for removing product and coolant from the reactor shell, and a plurality of the cooling modules described above, typically placed in parallel.

In one aspect, the reactor comprises a grid or set of beams for supporting the modules near the bottom of the reactor and optionally one or more further grids or sets of beams for guiding the modules during installation in and removal from the reactor.

In another aspect, at least some of the modules comprise a skirt, e.g. attached to or as an integral part of the beams or grid or directly to the corresponding modules or attached to the walls, for trapping feed gas underneath the modules. To enter the modules, gas has to pass through the inlet headers of the modules. As a result of differences in pressure drop over individual modules, reactant gas might follow a preferred path (bypass) instead of being evenly distributed over the modules. By trapping reactant gas underneath the modules, bypass of gas can be reduced or avoided.

A skirt preferably has a thickness in the range of from 0.5 mm to 12 mm, more preferably in the range of from 2 to 10 mm. A skirt preferably extends downwards from the module with a length in the range of from 10 cm to 5 m, more preferably 10 cm to 2 m, even more preferably in the range of from 50 cm to 1 m. The width of the skirt, horizontally along a side of the cooling module, preferably is in the range of from 5 cm to 15 m, more preferably in the range of from 1 m to 9 m.

The reactants inlet of the reactor may be connected to a gas distribution system with several gas outlets. A gas distribution system may, for example, consist of pipes with orifices, nozzles and/or spargers. The gas outlets of the gas distribution system are preferably directed towards the bottoms of the distribution chambers of the cooling modules, as the gas has to pass through the bottom headers of the cooling modules.

As mentioned above, skirts may be applied to guide the gas flow so that reactant gas is evenly distributed over the cooling modules. The gas outlets of a gas distribution system are in that case preferably directed to the cavities under the cooling modules that are defined by the skirts, after which the reactant gas can pass through the passages extending through the distribution chambers of the cooling modules.

A cooling module according to the invention, and the optional walls, baffles, skirts and gas distribution system in a reactor according to the invention preferably are able to withstand the conditions of an exothermic reaction. More preferably, they are able to withstand Fischer Tropsch reaction conditions. A cooling module, wall, baffle, and/or skirt can be made of any material, and preferably is made of sheet metal, titanium, carbon steel, graphite, stainless steel, alumina, and/or carbon fibre reinforce steel. A cooling module, wall, baffle, and/or skirt is most preferably steel, especially carbon steel or stainless steel.

The reactor preferably comprises between 1 and 100 cooling modules, more preferably between 2 and 100 cooling modules, even more preferably between 12 and 65, most preferably between 24 and 50.

The invention will now be explained in more detail with reference to the drawings, which show an example of a cooling module and reactor according to the invention.

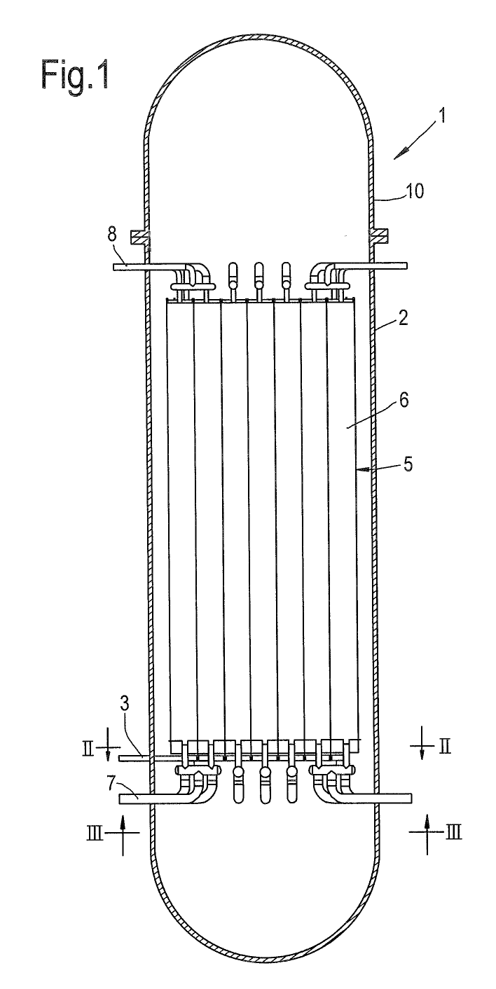

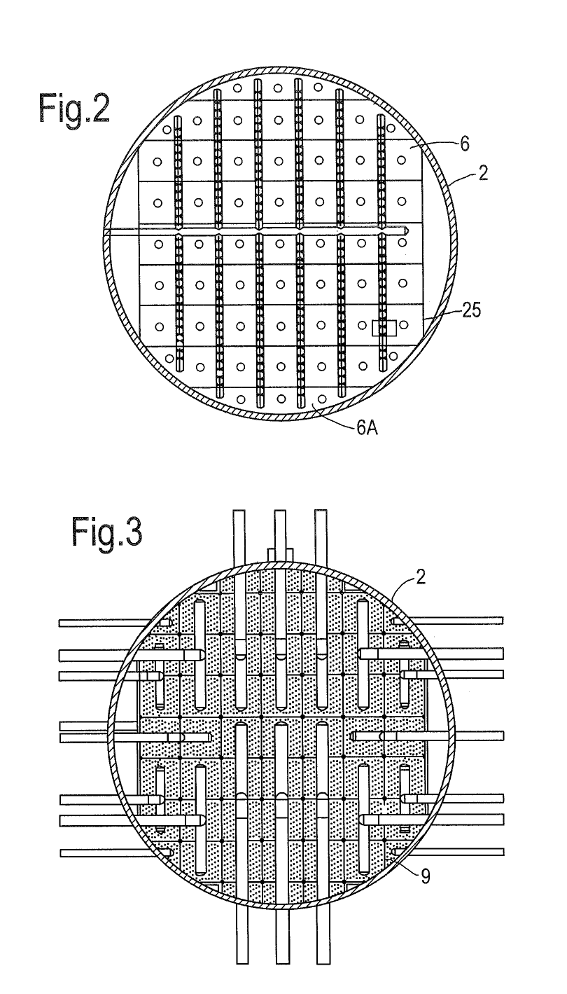

FIGS. 1 to 3 show a reactor 1 for carrying out an exothermic process, such as a Fischer-Tropsch process, comprising a reactor shell 2, at least one reactant inlet 3, at least one product outlet (not shown), at least one top outlet and liquid-gas separator (not shown), a cooling system 5 comprising a plurality of cooling modules 6, and inlets 7 and outlets 8 for a coolant. The reactor 1 further comprises near its bottom a grid 9 for supporting the modules 6 inside the reactor 1 and, along its height, further grids or beams (not shown) for guiding and laterally supporting the cooling modules 6 inside the reactor 1.

The upper part of the reactor 1 comprises a flanged dome 10 having an inner diameter equal to that of the main cylindrical section of the reactor 1, which dome 10 provides access to the interior of the reactor 1 and enables the cooling modules 6 to be installed in and removed from the reactor 1.

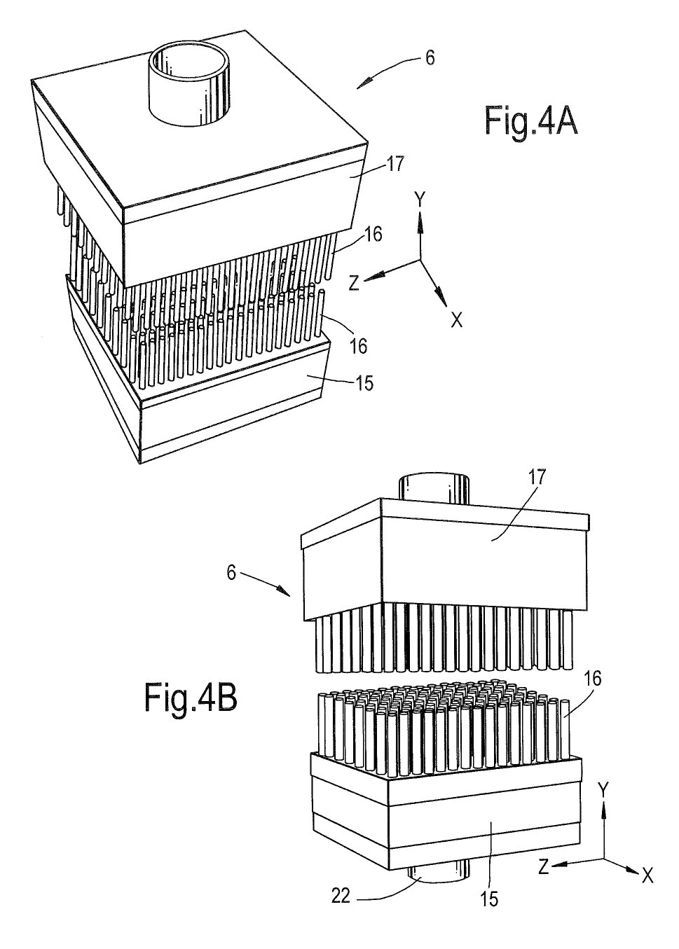

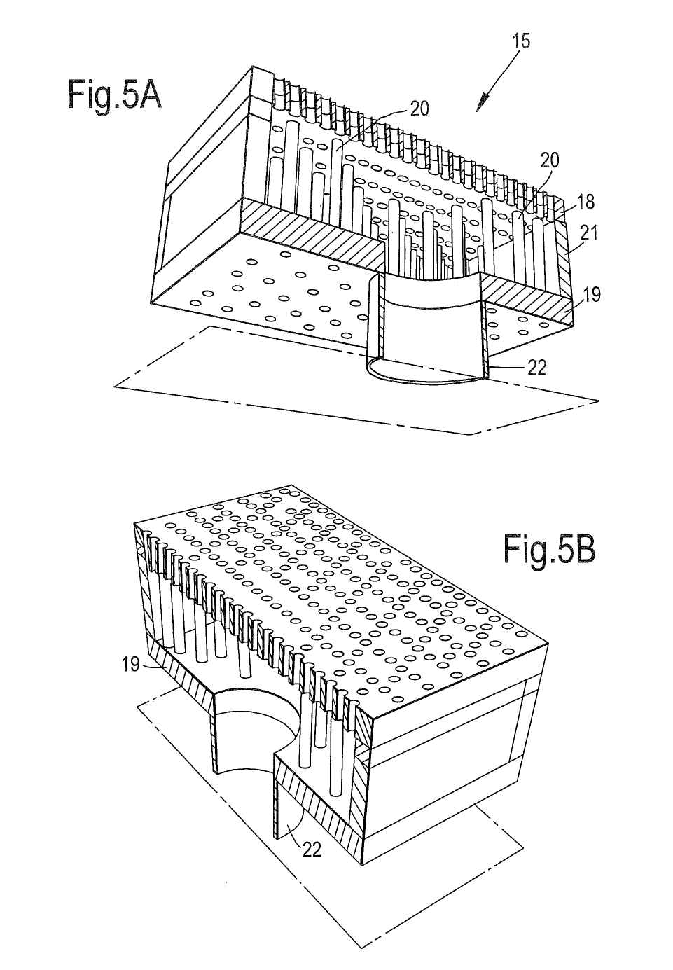

FIGS. 4A to 9 show a cooling module 6 having a square cross-section and comprising, from bottom to top, a coolant distribution chamber 15, an array of cooling tubes 16, and a coolant collection chamber 17.

The distribution chamber 15 in turn comprises two at least substantially parallel plates 18, 19 interconnected by means of passage tubes 20 and side walls 21, i.e. the tubes 20 extend through the distribution chamber 15 and the plates 18, 19 to enable fluid communication between the space underneath the distribution chamber 15 and the space between the cooling tubes 16.

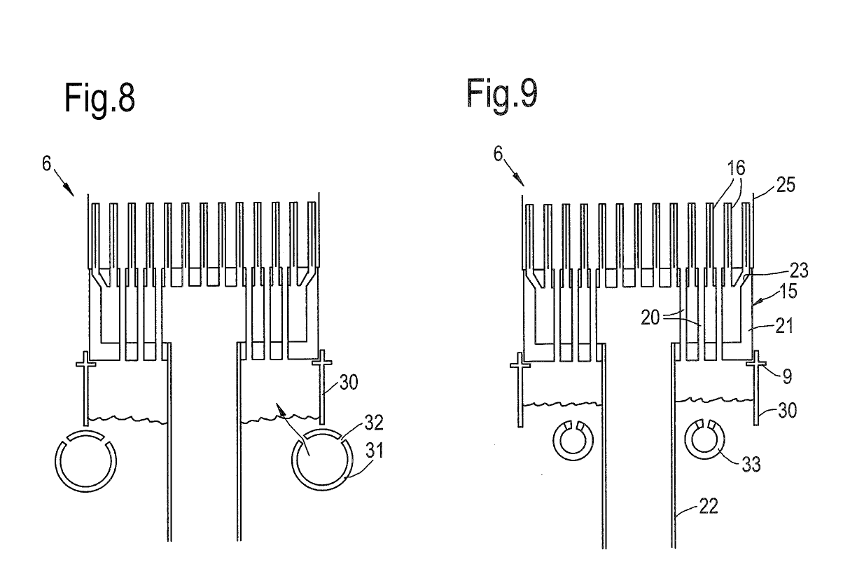

The bottom plate 19 of the distribution chamber 15 comprises a central coolant inlet 22, whereas the top plate 18 provides the connections to the cooling tubes 16. To increase the cooling capacity of the modules 6, further channels 23 for coolant are provided in the side walls 21 of the distribution chamber 15, as shown in FIGS. 8 and 9.

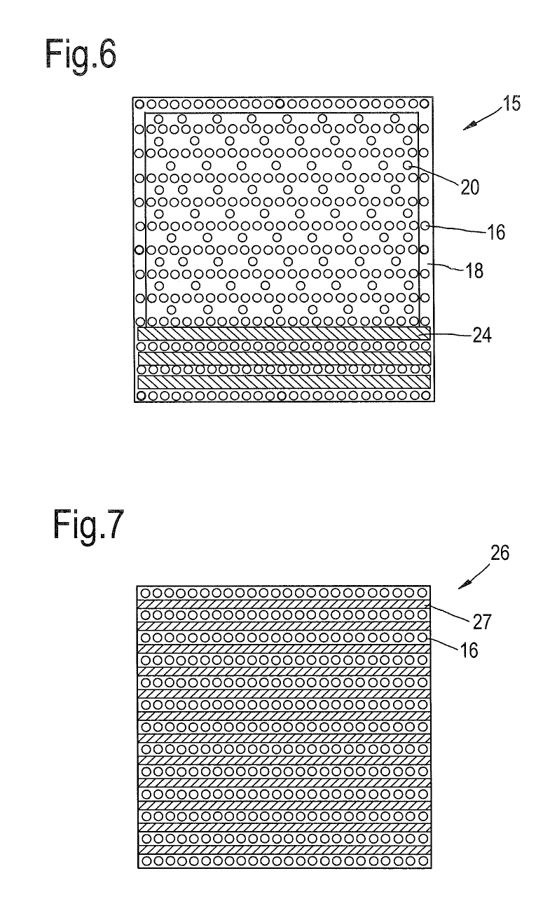

As shown in FIGS. 6 and 7, the cooling tubes 16 are arranged in rows separated by a distance sufficient to accommodate a structured catalyst, in particular shaped porous structures such as woven or non-woven and optionally compressed metal fabrics, e.g. in the form of blankets 24 (only three shown), between the rows of cooling tubes 16. Fischer-Tropsch catalysts are known in the art and typically include a Group VIII metal component, preferably cobalt, iron and/or ruthenium, more preferably cobalt. Suitable catalyst structures are disclosed in, e.g., WO 2006/037776 and WO 2007/068732.

As shown in plan view in FIG. 6, the tubes 20 for feedings the reactants through the distribution chamber 15 are arranged between the rows of cooling tubes 16 and discharge directly below the catalyst structures 24.

In the embodiment shown in the Figures, the collection chamber 17 is identical to the distribution chamber 15. However, typically, the collection chamber will be different, e.g. may comprise an outlet having a larger diameter to take account of the increased volume of evaporated coolant.

The cooling tubes 16 are enveloped by walls 25 (omitted in FIGS. 4A to 7) extending from the distribution chamber 15 to the collection chamber 17 to contain reactants and product within the module 6. In an alternative embodiment, the wall(s) terminate at a distance below the collection chamber, e.g. extend just up to the top level of the structured catalyst (catalyst bed) in the reactor.

Baffles 26 comprising, as shown in FIG. 7, rows of relatively small perforations 27 are provided at regular intervals along the length of the cooling tubes 16 to redistribute the gas and product inside the modules 6 and to provide support for the structured catalyst 24.

The cooling modules 6A adjacent the reactor wall 2 have a different cross-section to maximize reactor volume utilization.

As shown in FIGS. 8 and 9, the grid 9 supporting the modules 6 extends downwards to form a skirt 30 below each of the modules 6 for trapping gas. In the embodiment shown in FIG. 8, pipes 31 run below and parallel to the skirts 30 and are provided with orifices 32 or nozzles directed towards the cavities defined by the skirts 30. In the alternative embodiment shown in FIG. 9, an annular pipe 33 is provided around the inlet 22 of each of the modules 6.

During operation, coolant, typically water and/or steam, is fed through the inlet 7 to the distribution chamber of each of the modules 6. There, the coolant is distributed over the cooling tubes 16 and flows through the tubes 16 to the collection chamber 17 where it is collected and discharged via the outlet 8. Heat is transferred from the structured catalyst and the liquid surrounding the cooling tubes 16 to the coolant as it passes through the modules 6 and in particular as the coolant flows through the cooling tubes 16.

Syngas is fed through the inlet 3 to the pipes 31, and into the cavities defined by the skirts 30. By trapping reactant gas underneath the modules, bypass of gas can be reduced or avoided.

The modules can be installed by removing the dome and subsequently lowering the cooling modules into position in the reactor shell without the need for any personnel to be inside at the bottom of the reactor.

The invention is not limited to the embodiment described above, which can be varied in several ways within the scope of the claims. For instance, the reactor can be provided with a sub-dome or manhole, having a diameter significantly smaller than that of the cylindrical section of the reactor. In that case, internal lifting means (not shown) such as a temporary internal hoist fixed in the space above the cooling modules and below the ceiling of the reactor shell can be provided to facilitate lateral movement of the modules within the reactor shell, e.g. from the central-most position to the designated positions and vice versa.

In a further example, the reactor according to the present invention can be used for other exothermic processes including hydrogenation, hydroformylation, alkanol synthesis, the preparation of aromatic urethanes using carbon monoxide, Kölbel-Engelhard synthesis, and polyolefin synthesis.

What is claimed is:

1. A cooling module for use in a reactor for carrying out an exothermic process, such as a Fischer-Tropsch process, comprising a coolant inlet, a coolant distribution chamber, a plurality of cooling tubes, a coolant collection chamber, and a coolant discharge, wherein the module comprises one or more passages extending through the distribution chamber to enable fluid communication between the space on one side of the distribution chamber and the space between the cooling tubes, and wherein at least 80% of the cooling tubes are arranged separately with a distance to the nearest cooling tube of at least 1 cm.

2. A cooling module according to claim 1, comprising one or more passages extending through the collection chamber to enable fluid communication between the space between the cooling tubes and the space above the collection chamber.

3. A cooling module according to claim 1, wherein the passages comprise a plurality of tubes, and wherein at least one of the distribution chamber and the collection chamber comprises two at least substantially parallel plates interconnected by means of the tubes.

4. A cooling module according to claim 1, wherein a structured catalyst is placed between the cooling tubes.

5. A cooling module according to claim 1, wherein the cooling tubes are enveloped by one or more walls to contain reactants and product within the module.

6. A cooling module according to claim 1, comprising one or more baffles along the height of the module, the baffles preferably comprising perforations to redistribute the reactants over the cross-section of the module.

7. A reactor for carrying out an exothermic process comprising a reactor shell, inlets for introducing reactants and coolant into the reactor shell, outlets for removing product and coolant from the reactor shell, and a plurality of cooling modules, each module comprising a coolant inlet, a coolant distribution chamber, a plurality of cooling tubes, a coolant collection chamber, and a coolant discharge, wherein the module comprises one or more passages extending through the distribution chamber to enable fluid communication between the space on one side of the distribution chamber and the space between the cooling tubes, and wherein at least 80% of the cooling tubes are arranged separately with a distance to the nearest cooling tube of at least 1 cm.

8. A reactor according to claim 7, comprising for at least some of the modules a skirt for trapping gas underneath the modules.

9. A reactor according to claim 8, wherein at least some of the skirts are provided with an individual gas supply; wherein the gas supplies preferably comprise pipes running below and parallel to the skirts and are provided with orifices or nozzles directed towards the cavities defined by the skirts.
